(19) United States
(12) Patent Application Publication
(10) Pub. No.: US 2020/0271269 A1
(43) Pub. Date: Aug. 27, 2020

(54) METHOD OF CONTROLLING GIMBAL, GIMBAL, AND UNMANNED AERIAL VEHICLE

(71) Applicant: SZ DJI TECHNOLOGY CO., LTD., Shenzhen (CN)

(72) Inventors: Shuai LIU, Shenzhen (CN); Yingzhi WANG, Shenzhen (CN); Wenjun WANG, Shenzhen (CN)

(21) Appl. No.: 16/871,853

(22) Filed: May 11, 2020

Related U.S. Application Data
(63) Continuation of application No. PCT/CN2017/112318, filed on Nov. 22, 2017.

(51) Int. Cl. F16M 11/18; B64C 39/02; B64D 47/08; G05B 19/042

(52) U.S. Cl. CPC F16M 11/18; B64C 39/024; H04N 5/2253; G05B 19/042; B64D 47/08

(57) ABSTRACT

The present disclosure relates to a method for controlling a gimbal. The method includes determining whether there is a mechanical limit in the process of a gimbal moving from a current attitude to an expected attitude in a shortest path. When it is determined that there is a mechanical limit, the gimbal is controlled to move from the current attitude to the expected attitude according to a target moving direction, where the target moving direction is a moving direction opposite to a direction in which the gimbal moves from the current attitude to the expected attitude in the shortest path.

### CROSS-REFERENCE TO RELATED APPLICATION

This application is a continuation of International Application No. PCT/CN2017/112318, filed Nov. 22, 2017, the entire content of which is incorporated herein by reference.

### TECHNICAL FIELD

The present disclosure relates to the field of control technology and, more particularly, to a method of controlling a gimbal, a gimbal, and an unmanned aerial vehicle thereof.

### BACKGROUND

A gimbal is a device that stabilizes the payload. The payload may be, for example, a photographing device. The gimbal stabilizes the photographing device, allowing the photographing device mounted on the gimbal to capture smooth and stable pictures.

At present, under normal circumstances, a gimbal configures corresponding mechanical limits in one or more of the yaw direction, the pitch direction, and the roll direction, so that the gimbal cannot conduct unlimited rotations in these directions. According to the existing gimbal control strategy, a gimbal will move from the current attitude to an expected attitude in the shortest path. However, there may be a mechanical limit in the process, which then causes the gimbal to get stuck in the limit position, resulting in unfriendly user experience.

### SUMMARY

In accordance with the present disclosure, there is provided a method for controlling a gimbal. The method includes determining whether there is a mechanical limit in a process of a gimbal moving from a current attitude to an expected attitude in a shortest path. When it is determined that there is a mechanical limit, the gimbal is controlled to move from the current attitude to the expected attitude according to a target moving direction, where the target moving direction is a moving direction opposite to a direction in which the gimbal moves from the current attitude to the expected attitude in the shortest path.

Also in accordance with the disclosure, there is provided a gimbal. The gimbal includes a memory and a processor. The memory is configured to store program code. The processor calls the program code. When the program code is executed, the processor determines whether there is a mechanical limit in a process of a gimbal moving from a current attitude to an expected attitude in a shortest path. When it is determined that there is a mechanical limit, the processor controls the gimbal to move from the current attitude to the expected attitude according to a target moving direction, where the target moving direction is a moving direction opposite to a direction in which the gimbal moves from the current attitude to the expected attitude in the shortest path.

### BRIEF DESCRIPTION OF THE DRAWINGS

FIG. 1 is a schematic structural diagram of a gimbal according to an embodiment of the present disclosure;

FIG. 2 is a schematic diagram illustrating a possible mechanical limit met by a moving gimbal according to an embodiment of the present disclosure;

FIG. 3 is a flowchart of a method for controlling a gimbal according to an embodiment of the present disclosure;

FIG. 4 is a flowchart of a method for controlling a gimbal according to another embodiment of the present disclosure;

FIG. 5 is a schematic diagram for determining whether there is a mechanical limit in a process of a gimbal moving from a current yaw attitude to an expected yaw attitude according to an embodiment of the present disclosure;

FIG. 6 is a schematic diagram for determining whether there is a mechanical limit in a process of a gimbal moving from a current yaw attitude to an expected yaw attitude according to another embodiment of the present disclosure;

FIG. 7 is a schematic diagram for determining whether there is a mechanical limit in a process of a gimbal moving from a current yaw attitude to an expected yaw attitude according to yet another embodiment of the present disclosure;

FIG. 8 is a schematic diagram for determining whether there is a mechanical limit in a process of a gimbal moving from a current yaw attitude to an expected yaw attitude according to yet another embodiment of the present disclosure; and

FIG. 9 is a schematic structural diagram of a gimbal according to an embodiment of the present disclosure.

### DETAILED DESCRIPTION OF THE EMBODIMENTS

Technical solutions of the present disclosure will be described in detail with reference to the accompanying drawings. It will be appreciated that the described embodiments are some rather than all of the embodiments of the present disclosure. Other embodiments conceived by those having ordinary skills in the art on the basis of the described embodiments without inventive efforts should fall within the scope of the present disclosure.

As used herein, when a first assembly is referred to as “fixed to” a second assembly, it is intended that the first assembly may be directly attached to the second assembly or may be indirectly attached to the second assembly via another assembly. When a first assembly is referred to as “connecting” to a second assembly, it is intended that the first assembly may be directly connected to the second assembly or may be indirectly connected to the second assembly via a third assembly between them. The terms “perpendicular,” “horizontal,” “left,” “right,” and similar expressions used herein are merely intended for description.

Unless otherwise defined, all the technical and scientific terms used herein have the same or similar meanings as generally understood by one of ordinary skill in the art. As described herein, the terms used in the specification of the present disclosure are intended to describe exemplary embodiments, instead of limiting the present disclosure. The term “and/or” used herein includes any suitable combination of one or more related items listed.

The following descriptions explain example embodiments of the present disclosure, with reference to the accompanying drawings. Unless otherwise noted as having an obvious conflict, the embodiments or features included in various embodiments may be combined.

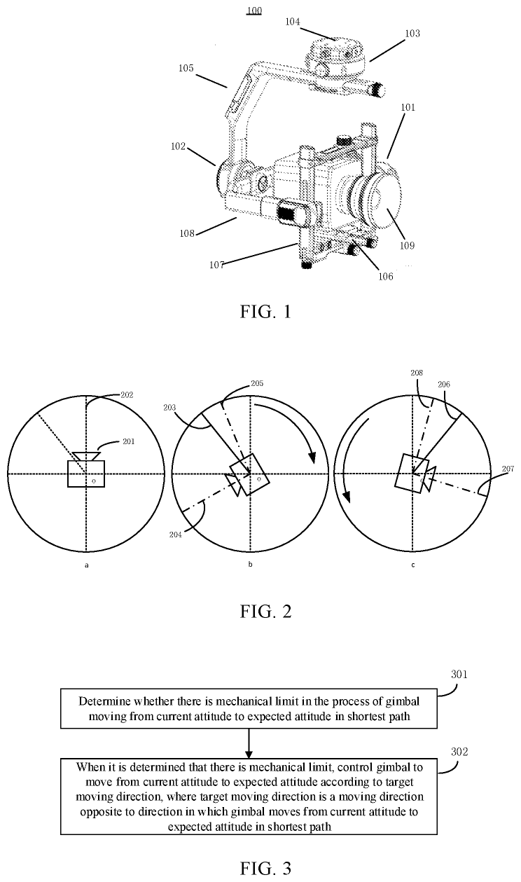

A gimbal is a device for stabilizing the payload mounted on the gimbal. The payload may be a photographing device, and the gimbal may also adjust the operation direction of the payload. For example, the gimbal may adjust the shooting direction of the photographing device. The gimbal in the embodiments of the present disclosure may be a handheld gimbal or a gimbal built on a movable platform. The movable platform may be an unmanned aerial vehicle, an unmanned mobile vehicle, or the like. In addition, the gimbal in the embodiments of the present disclosure may be a two-axis gimbal or a multi-axis gimbal. Here, a three-axis gimbal is used as an example for schematic description. FIG. 1 is a schematic structural diagram of a gimbal according to an embodiment of the present disclosure. The gimbal may specifically be a handheld gimbal. As shown in FIG. 1, the gimbal 100 includes a pitch axis motor 101, a roll axis motor 102, a yaw axis motor 103, a gimbal base 104, a yaw axis arm 105, a photographing device fixing mechanism 106, a pitch axis arm 107, and a roll axis arm 108, where the photographing device fixing mechanism 106 may be disposed on the pitch axis arm 107 for fixing a photographing device 109. The pitch axis motor 101 is configured to drive the photographing device 109 to rotate in the pitch direction, the roll axis motor 102 is configured to drive the photographing device 109 to rotate in the roll direction, and the yaw axis motor 103 is configured to drive the photographing device 109 to rotate in the yaw direction. The photographing device fixing mechanism 106 includes an inertial measurement unit (IMU) for detecting the attitude of the photographing device 109, where the attitude of the photographing device 109 represents the attitude of the gimbal. That is, the yaw attitude of the photographing device 29 is the yaw attitude of the gimbal, the pitch attitude of the photographing device 109 is the pitch attitude of the gimbal, and the roll attitude of the photographing device 109 is the roll attitude of the gimbal.

Currently, in certain conditions, a gimbal sets a corresponding mechanical limit in one or more of the yaw direction, the pitch direction, and the roll direction, so that the gimbal cannot conduct unlimited rotations in this direction(s). In the following, the yaw direction is used as an example for illustrative purposes. For ease of explanation, the rotation of the photographing device in the yaw direction is used to represent the rotation of the gimbal in the yaw direction. As shown in FIG. 2a, the photographing device 201 is in the reference yaw attitude 202 at the initial moment, where the reference yaw attitude 202 is the yaw attitude of the photographing device 201 when the joint angle of the yaw axis motor is 0 degree, that is, the yaw attitude in which the photographing device 201 returns to the central position in the yaw direction. The yaw attitude may be represented by a yaw attitude angle. As shown in FIG. 2b, if the photographing device moves clockwise in the yaw direction as shown in the figure, that is, the gimbal moves clockwise in the yaw direction as shown in FIG. 2b, when the photographing device rotates to a limit position 203, the gimbal will have a mechanical limit. That is, the gimbal will reach the limit angle when moving clockwise in the yaw direction, and the gimbal cannot continue to rotate clockwise. At one moment, if the photographing device 201 is in an attitude 204, and the gimbal receives an attitude control command from a user to instruct the gimbal to move to an expected attitude 205, according to the existing gimbal control strategy, the gimbal selects the shortest path to move from the current attitude 204 to the expected attitude 205. That is, the gimbal will move clockwise in the yaw direction to the expected attitude 205, as shown in FIG. 2b. However, the gimbal will have a mechanical limit in the process of moving from the current attitude 204 to the expected attitude 205. As a result, the gimbal will get stuck at the limit attitude 203 and cannot reach the expected attitude 205.

Similarly, as shown in FIG. 2c, if the photographing device moves counterclockwise in the shown yaw direction, that is, if the gimbal moves counterclockwise in the yaw direction, when the photographing device rotates to the limit position 206, that is, the gimbal reaches the limit angle when moving counterclockwise in the yaw direction, the gimbal will have a mechanical limit, and the gimbal cannot continue to rotate counterclockwise. At one moment, if the photographing device 201 is in an attitude 207, and the gimbal receives an attitude control command from a user to instruct the gimbal to move to an expected attitude 208, according to the existing gimbal control strategy, the gimbal selects the shortest path to move from the current attitude 207 to the expected attitude 208. That is, the gimbal will move counterclockwise in the yaw direction to the expected attitude 208, as shown in the figure. However, the gimbal will have a mechanical limit during the movement from the current attitude 207 to the expected attitude 208. As a result, the gimbal will get stuck at the limit attitude 207 and cannot reach the expected attitude 208. In summary, in the process of a gimbal moving from a current attitude to an expected attitude, the gimbal may experience a mechanical limit, and thus cannot reach the expected attitude. This will cause confusion for users and thus fails to achieve the desired control functions.

Embodiments of the present disclosure provide a method for controlling a gimbal. FIG. 3 is a flowchart of a method according to an embodiment of the present disclosure. As shown in FIG. 3, the method in the disclosed embodiment may include:

Step S301: Determine whether there is a mechanical limit in the process of the gimbal moving from the current attitude to the expected attitude in the shortest path.

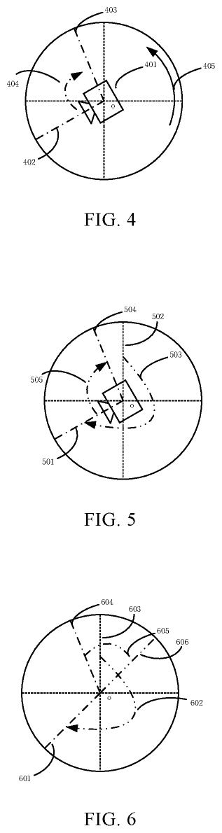

Specifically, the execution entity of the method in the disclosed embodiment may be a gimbal and, more particularly, the execution entity may be a processor of the gimbal. As shown in FIG. 4, when the gimbal 401 needs to move from the current attitude 402 to the expected attitude 403, the processor of the gimbal may determine whether there is a mechanical limit in a process of the gimbal moving from the current attitude 402 to the expected attitude 403 in the shortest path 404. When there is a mechanical limit in the process, the gimbal will get stuck in the limit attitude, and the gimbal cannot move from the current attitude 402 to the expected attitude 403 in the shortest path.

Step S302: When it is determined that there is a mechanical limit, control the gimbal to move from the current attitude to the expected attitude according to a target moving direction, where the target moving direction is a moving direction opposite to the direction in which that the gimbal moves from the current attitude to the expected attitude in the shortest path.

When the processor determines that there is a mechanical limit in the process of the gimbal moving from the current attitude 402 to the expected attitude 403 in the shortest path 404, according to the control strategy in the existing technology, the gimbal cannot be controlled to move from the current attitude 402 to the expected attitude 403 in a moving direction indicated by the shortest path 404. To circumvent the mechanical limit, the processor may control the gimbal to move from the current attitude 402 to the expected attitude 403 according to a target moving direction 405. Here, the target moving direction 405 is a moving direction that is opposite to the direction in which the gimbal moves from the current attitude 402 to the expected attitude 403 in the shortest path 404. That is, the target moving direction 405 is a moving direction that is opposite to the direction indicated by the shortest path 404.

In some embodiments, when it is determined that there is no mechanical limit, the gimbal is controlled to follow the shortest path from the current attitude to the expected attitude. Specifically, when the processor determines that there is no mechanical limit in the process of the gimbal moving from the current attitude 402 to the expected attitude 403 in the shortest path 404, the processor controls the gimbal to move from the current attitude 402 to the expected attitude 403 in the shortest path 404. In summary, when there is a mechanical limit in the process of the gimbal moving from the current attitude 402 to the expected attitude 403, the gimbal may move from the current attitude 402 to the expected attitude 403 according to the target moving direction, so that the gimbal will not get stuck in the limit attitude. When there is no mechanical limit in the process of the gimbal moving from the current attitude 402 to the expected attitude 403, the gimbal may move from the current attitude 402 to the expected attitude 403 in the shortest path, to ensure the control efficiency of the gimbal. Through this technical solution, the gimbal control strategy is enriched, which ensures the accuracy and efficiency in controlling a gimbal attitude.

The method for controlling a gimbal provided by the disclosed embodiments determines whether there is a mechanical limit in the process of the gimbal moving from the current attitude to the expected attitude in the shortest path. When it is determined that there is a mechanical limit, the gimbal is controlled to move from the current attitude to the expected attitude in a direction opposite to the shortest path. This ensures that the gimbal will not get stuck in the limit attitude, and thus the gimbal control strategy is optimized.

In some embodiments, determining whether there is a mechanical limit in the process of the gimbal moving from the current attitude to the expected attitude in the shortest path includes: determining whether there is a mechanical limit in the process of the gimbal moving from a current yaw attitude to an expected yaw attitude in the shortest path. Accordingly, the aforementioned control process (i.e., when it is determined that there is a mechanical limit, controlling the gimbal to move from the current attitude to the expected attitude according to a target moving direction, where the target moving direction is a moving direction opposite to the direction in which the gimbal moves from the current attitude to the expected attitude in the shortest path) includes: when it is determined that there is a mechanical limit, controlling the gimbal to move from the current yaw attitude to the expected yaw attitude according to a target yaw moving direction, where the target yaw moving direction is a moving direction opposite to the direction in which the gimbal moves from the current yaw attitude to the expected yaw attitude in the shortest path.

Specifically, for the gimbal movement in the yaw direction, after determining an expected yaw attitude, the gimbal may determine whether there is a mechanical limit in the process of the gimbal moving from the current yaw attitude to the expected yaw attitude in the shortest path. When it is determined that there is a mechanical limit, the gimbal is controlled to move from the current yaw attitude to the expected yaw attitude according to a target yaw moving direction. Here the target yaw moving direction is a moving direction opposite to the direction in which the gimbal moves from the current yaw attitude to the expected yaw attitude in the shortest path. When it is determined that there is no mechanical limit, the gimbal is controlled to move from the current yaw attitude to the expected yaw attitude in the shortest path, where the shortest path may be a shortest yaw path.

The specific implementations of determining whether there is a mechanical limit in the process of the gimbal moving from the current yaw attitude to the expected yaw attitude in the shortest path will be made in detail hereinafter. There are several possible ways of determining whether there is a mechanical limit in the process of the gimbal moving from the current yaw attitude to the expected yaw attitude in the shortest path.

In one implementation: determining a rotation angle, relative to an reference yaw attitude, at which the gimbal rotates when moving from the current yaw attitude to the expected yaw attitude in the shortest path; and, according to the rotation angle, determining whether there is a mechanical limit in the process of the gimbal moving from the current yaw attitude to the expected yaw attitude in the shortest path.

Specifically, when a gimbal is in the current yaw attitude 501, a rotation angle 503 at which the gimbal has rotated in the yaw direction relative to the reference yaw attitude 502 may be determined. After determining the expected yaw attitude of the gimbal, a rotation angle 505 at which the gimbal moves from the current yaw attitude 501 to the expected yaw attitude 504 in the shortest path may be determined. According to the rotation angle 503 and the rotation angle 505, an angle α, relative to the reference yaw attitude, at which the gimbal moves from the current yaw attitude to the expected yaw attitude in the shortest path may be determined. Further, according to the relationship between the rotation angle α and the yaw limit angle, it may be determined whether there is a mechanical limit in the process of the gimbal moving from the current yaw attitude to the expected yaw attitude in the shortest path. As described above, the reference yaw attitude is a yaw attitude when the joint angle of the yaw axis motor of the gimbal is 0 degree, that is, a yaw attitude when the gimbal returns to the central position in the yaw direction. The yaw limit angle may be a maximum angle at which the gimbal may rotate relative to the reference yaw attitude in the yaw direction. In practical applications, the rotation angle 503 may be determined by the joint angle of the yaw axis motor, and the rotation angle 505 may be determined based on the yaw attitude difference between the current yaw attitude 501 and the expected yaw attitude 504. Specifically, the rotation angle 505 may be determined based on the attitude angle difference between a yaw attitude angle corresponding to the current yaw attitude and a yaw attitude angle corresponding to the expected yaw attitude.

Further, determining, according to the rotation angle α, whether there is a mechanical limit in the process of the gimbal moving from the current yaw attitude to the expected yaw attitude includes: when the rotation angle α is greater than the yaw limit angle, it is determined that there is a mechanical limit in the process of the gimbal moving from the current yaw attitude to the expected yaw attitude in the shortest path. That is, when the gimbal moves from the current yaw attitude to the expected yaw attitude, if the rotation angle of the gimbal relative to the reference yaw attitude is greater than the yaw limit angle, it is determined that there is a mechanical limit in the process of the gimbal moving from the current yaw attitude to the expected yaw attitude in the shortest path. When the rotation angle α is smaller than the yaw limit angle of the gimbal, it is determined that there is no mechanical limit in the process of the gimbal moving from the current yaw attitude to the expected yaw attitude in the shortest path.

In another implementation: determining an angle difference between the joint angle of the yaw axis motor of the gimbal in the current yaw attitude and the yaw attitude angle of the gimbal in the expected yaw attitude; and, according to the angle difference, determining whether there is a mechanical limit in the process of the gimbal moving from the current yaw attitude to the expected yaw attitude in the shortest path.

Specifically, as shown in FIG. 6, when the gimbal is in the current yaw attitude 601, the joint angle 602 of the yaw axis motor of the gimbal may be determined, where the joint angle 602 may reflect a direction in which the gimbal moves from the reference yaw attitude 603 to the current yaw attitude 601. When the gimbal moves from the reference yaw attitude 603 to the current attitude 601, if the gimbal continues to rotate, the gimbal will reach the limit position 604. When the attitude angle corresponding to the expected attitude is located in the yaw attitude angle range 605 as shown in the figure, there is a mechanical limit in the process of the gimbal moving from the current yaw attitude 601 to the expected yaw attitude in the shortest path. Here, the yaw attitude angle range 605 is a range of yaw attitude angles between the limit position 604 and a yaw transition attitude 606, where the yaw transition attitude 606 is determined according to the current yaw attitude 601. For instance, for a photographing device mounted on the gimbal, the shooting direction in the yaw transition attitude 606 is opposite to the shooting direction in the current yaw attitude 601. Next, the angle difference, between the joint angle of the yaw axis motor of the gimbal in the current yaw attitude and the yaw attitude angle of the gimbal in the expected yaw attitude, may be determined. According to the difference, it may be determined whether the yaw attitude angle corresponding to the expected yaw attitude is located in the yaw attitude angle range 605 as shown in the figure. By determining whether the yaw attitude angle corresponding to the expected yaw attitude is located in the yaw attitude angle range 605 as shown in the figure, it may be determined whether there is a mechanical limit in the process of the gimbal moving from the current yaw attitude to the expected yaw attitude in the shortest path.

Further, when the joint angle of the yaw axis motor of the gimbal in the current yaw attitude is within a first yaw joint angle range, and when the angle difference satisfies a first preset yaw angle requirement, determining whether there is a mechanical limit in the process of the gimbal moving from the current yaw attitude to the expected yaw attitude in the shortest path; and when the joint angle of the yaw axis motor of the gimbal in the current yaw attitude is within a second yaw joint angle range, and when the angle difference satisfies a second preset yaw angle requirement, determining whether there is a mechanical limit in the process of the gimbal moving from the current yaw attitude to the expected yaw attitude in the shortest path.

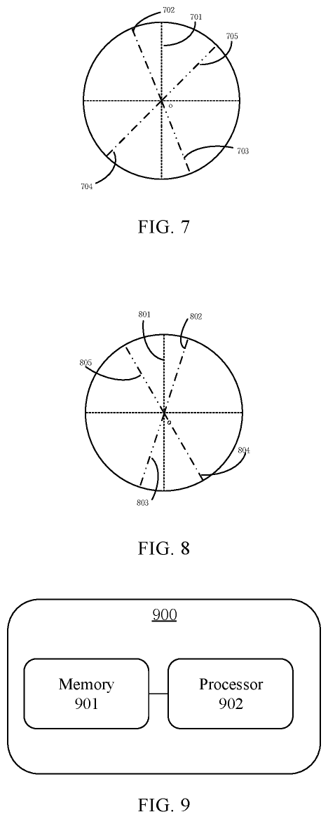

Specifically, as shown in FIG. 7, the gimbal will be mechanically limited when moving clockwise from the reference attitude 701 to the limit attitude 702 in the yaw direction. From the analysis, it can be seen that when the gimbal moves clockwise, if the current yaw attitude of the gimbal is between the reference yaw attitude 701 and the limit transition attitude 703, the gimbal may reach any expected attitude with a shortest path, and there is no mechanical limit. Here, the limit transition attitude 703 is determined according to the limit attitude 702. That is, the shooting direction of the photographing device mounted on the gimbal in the limit attitude 702 is opposite to the shooting direction in the limit transition attitude 703. For the purpose of illustration, when the current yaw attitude of the gimbal is set to 704 as shown in the figure, it may be seen from the analysis that when the current yaw attitude 704 of the gimbal is between the limit transition attitude 703 and the limit attitude 702, that is, when the joint angle of the yaw axis motor of the gimbal in the current yaw attitude is within a first yaw joint angle range, and when the expected yaw attitude is between the limit attitude 702 and the yaw transition attitude 705, it is determined that there is a mechanical limit in the process of the gimbal moving to the expected attitude in the shortest path. Here, the yaw transition attitude 705 is determined according to the current yaw attitude 704. That is, the shooting direction of the photographing device mounted on the gimbal in the yaw transition attitude 705 is opposite to the shooting direction in the current yaw attitude 704. For the determining process (i.e., determining an angle difference between the joint angle of the yaw axis motor at the current yaw attitude 704 and the yaw attitude angle of the gimbal in the expected yaw attitude, when the angle difference indicates that the expected yaw attitude is between the limit attitude 702 and the yaw transition attitude 705, determining that there is a mechanical limit in the process of the gimbal moving to the expected attitude in the shortest path), the specific detail will be provided hereinafter.

For ease of explanation, when the gimbal moves clockwise, the joint angle of the yaw axis motor of the gimbal is positive. Assuming that the yaw limit angle of the gimbal is 340 degree, and the yaw attitude angle corresponding to the reference yaw attitude is 0 degree. In the clockwise direction, the yaw attitude angle is positive and only to the yaw attitude angle of 180 degree. In the counterclockwise direction, the yaw attitude angle is negative and only to the yaw attitude angle of −180 degree. That is, a yaw attitude with the yaw attitude angle at 180 degree is the same as a yaw attitude with the yaw attitude angle at −180 degree. In the clockwise direction, the yaw attitude angle corresponding to the limit attitude is −20 degree. When the current yaw attitude of the gimbal is between the limit transition attitude 703 and the limit attitude 702, that is, when the joint angle of the yaw axis motor of the gimbal in the current yaw attitude is within the first yaw joint angle range (i.e., between 160 degree and 340 degree), when it is determined that the expected yaw attitude is between the limit attitude 702 and the yaw transition attitude 705, then there is a mechanical limit in the process of the gimbal moving to the expected attitude in the shortest path. Assuming that the joint angle of the yaw axis motor in the current yaw attitude is 210 degree, when the angle difference between the joint angle of the current yaw axis motor and the yaw attitude angle of the gimbal in the expected yaw attitude is between a first yaw threshold angle and a second yaw threshold angle, it may be determined that the expected yaw attitude is between the limit attitude 702 and the yaw transition attitude 705. At this moment, when the gimbal moves to the expected attitude in the shortest path, there will be a mechanical limit. Here, the first yaw threshold angle is an angle difference between the yaw attitude angle of the gimbal in the limit attitude and the joint angle of the current yaw axis motor, i.e., −20−210=−230 degree. The second yaw threshold angle is an angle difference between the yaw attitude angle of the gimbal in the yaw transition attitude and the joint angle of the current yaw axis motor of the gimbal, that is, 30−210=−180 degree.

Similarly, as shown in FIG. 8, the gimbal moving counterclockwise from the reference attitude 801 to the limit attitude 802 in the yaw direction will be mechanically limited. It can be seen from the analysis that when the gimbal moves counterclockwise, when the current yaw attitude of the gimbal is between the reference yaw attitude 801 and the limit transition attitude 803, the gimbal may reach any expected attitude with a shortest path, and there is no mechanical limit. Here, the limit transition attitude is determined according to the limit attitude 802. That is, the shooting direction of the photographing device mounted on the gimbal in the limit attitude 802 is opposite to the shooting direction in the limit transition attitude 803. For the purpose of illustration, the current yaw attitude of the gimbal is set to 804 as shown in the figure, it can be seen from the analysis that when the current yaw attitude 804 of the gimbal is between the limit transition attitude 803 and the limit attitude 802, that is, when the joint angle of the yaw axis motor in the current yaw attitude is within the second yaw joint angle range, and when the expected yaw attitude is between the limit attitude 802 and the yaw transition attitude 805, it may be determined that there is a mechanical limit in the process of the gimbal moving to the expected attitude in the shortest path. Here, the yaw transition attitude 805 is determined according to the current yaw attitude 804. That is, the shooting direction of the photographing device, mounted on the gimbal, in the yaw transition attitude 805 is opposite to the shooting direction in the current yaw attitude 804. For the determining process (i.e., determining an angle difference between the joint angle of the yaw axis motor under the current yaw attitude 804 and the yaw attitude angle of the gimbal in the expected yaw attitude, when the difference indicates that the expected attitude is between the limit attitude 802 and the yaw transition attitude 805, determining that there is a mechanical limit in the process of the gimbal moving to the expected attitude in the shortest path), the specific detail will be provided hereinafter.

For ease of explanation, when the gimbal moves clockwise, the joint angle of the yaw axis motor of the gimbal is positive. Assuming that the yaw limit angle of the gimbal is 340 degree, and the yaw attitude angle corresponding to the reference yaw attitude is 0 degree. In the clockwise direction, the yaw attitude angle is positive and only to the yaw attitude angle of 180 degree. In the counterclockwise direction, the yaw attitude angle is negative and only to the yaw attitude angle of −180 degree. That is, the yaw attitude at a yaw attitude angle of 180 degree is the same as the yaw attitude at a yaw attitude angle of −180 degree. In the counterclockwise direction, the yaw attitude angle corresponding to the limit attitude is 20 degree. When the current yaw attitude of the gimbal is between the limit transition attitude 803 and the limit attitude 802, that is, when the joint angle of the yaw axis motor of the gimbal in the current yaw attitude is within the first yaw joint angle range (i.e., between −160 degree and −340 degree), it may be determined that the expected yaw attitude is between the limit attitude 802 and the yaw transition attitude 805, and there is a mechanical limit in the movement of the gimbal to the expected yaw attitude in the shortest path. Assuming that the joint angle of the yaw axis motor at the current yaw attitude is −210 degree, when the angle difference between the joint angle of the current yaw axis motor and the yaw attitude angle of the gimbal in the expected yaw attitude is between a third yaw threshold angle and a fourth yaw threshold angle, it is determined that there is a mechanical limit in the process of the gimbal moving to the expected attitude in the shortest path. Here, the third yaw threshold angle is an angle difference between the yaw attitude angle of the gimbal in the limit attitude and the joint angle of the current yaw axis motor of the gimbal, that is, 20−(−210)=230 degree. The fourth yaw threshold angle is an angle difference between the yaw attitude angle of the gimbal in the yaw transition attitude and the joint angle of the current yaw axis motor of the gimbal, that is, −30−(−210)=180 degree.

In the pitch direction, specific implementations for determining whether there is a mechanical limit in the process of the gimbal moving from the current pitch attitude to the expected pitch attitude in the shortest path is determined. There may be several feasible ways to determine whether there is a mechanical limit in the process of the gimbal moving from the current pitch attitude to the expected pitch attitude in the shortest path, where the shortest path may be a shortest pitch path.

In one implementation: determining a rotation angle, with respect to the reference pitch attitude, at which the gimbal rotates when moving from the current pitch attitude to the expected pitch attitude in the shortest path; and, according to the rotation angle, determining whether there is a mechanical limit in the process of the gimbal moving from the current pitch attitude to the expected pitch attitude in the shortest path.

Specifically, determining, according to the rotation angle, whether there is a mechanical limit in the process of the gimbal moving from the current pitch attitude to the expected pitch attitude includes: when the rotation angle is greater than a pitch limit angle of the gimbal, determining that there is a mechanical limit in the process of the gimbal moving from the current pitch attitude to the expected pitch attitude in the shortest path.

Further, the reference pitch attitude is a pitch attitude of the gimbal when the joint angle of the pitch axis motor of the gimbal is 0 degree.

In another implementation: determining an angle difference between the joint angle of the pitch axis motor of the gimbal in the current pitch attitude and the pitch attitude angle of the gimbal in the expected pitch attitude; and according to the angle difference, determining whether there is a mechanical limit in the process of the gimbal moving from the current pitch attitude to the expected pitch attitude in the shortest path.

Further, when the joint angle of the pitch axis motor of the gimbal in the current pitch attitude is within a first pitch joint angle range, and when the angle difference satisfies a first preset pitch angle requirement, determine whether there is a mechanical limit in the process of the gimbal moving from the current pitch attitude to the expected pitch attitude in the shortest path; and when the joint angle of the pitch axis motor in the current pitch attitude is within a second pitch joint angle range, and when the angle difference satisfies a second preset pitch angle requirement, determine whether there is a mechanical limit in the process of the gimbal moving from the current pitch attitude to the expected pitch attitude in the shortest path.

For the specific principles and explanations for determining whether there is a mechanical limit in the process of the gimbal moving from the current pitch attitude to the expected pitch attitude in the shortest path, refer to the determination process in the yaw direction, details of which will not be provided again for brevity purposes.

In some embodiments, a target position transmitted by an external device is received, and the expected attitude of the gimbal is determined according to the target position. Specifically, the external device may be any device other than the gimbal. In practical applications, the external device may be a control terminal of the gimbal, such as a remote controller, etc. When the gimbal is mounted on an unmanned aerial vehicle, the external device may be the unmanned aerial vehicle, and the gimbal may receive a target position sent by the external device. Here, the target position is a target position for directing the gimbal (i.e., a target position of the payload mounted on the gimbal), for example, for providing a target shooting direction of a photographing device. In certain situations, the target position is a position in a world coordinate system. In certain situations, when the external device is a device on an unmanned aerial vehicle, such as a flight controller on an unmanned aerial vehicle, the position may be a position in the body frame coordinate system of the unmanned aerial vehicle. After receiving the target position, the gimbal may convert the target position into an expected attitude of the gimbal. For example, when the target position is a target yaw position, the target yaw position may be converted into an expected yaw attitude of the gimbal. When the target position is a target pitch position, the target pitch position may be converted into an expected pitch attitude of the gimble.

Embodiments of the present disclosure provide a gimbal. FIG. 9 is a structural diagram of a gimbal according to an embodiment of the present disclosure. As shown in FIG. 9, the gimbal 900 in the disclosed embodiment may include a memory 901 and a processor 902.

The memory 901 is configured to store program code.

The processor 902 calls the program code, and performs the following operations when the program code is executed:

determining whether there is a mechanical limit in the process of the gimbal moving from the current attitude to the expected attitude in the shortest path;

when it is determined that there is a mechanical limit, controlling the gimbal to move from the current attitude to the expected attitude according to a target moving direction, where the target moving direction is a moving direction opposite to the direction in which the gimbal moves from the current attitude to the expected attitude in the shortest path.

In some embodiments, in determining whether there is a mechanical limit in the process of the gimbal moving from the current attitude to the expected attitude in the shortest path, the processor 902 is specifically configured to:

determine whether there is a mechanical limit in the process of the gimbal moving from a current yaw attitude to an expected yaw attitude in the shortest path;

in controlling the gimbal to move from the current attitude to the expected attitude according to the target moving direction when it is determined that there is a mechanical limit, the processor 902 is specifically configured to:

control the gimbal to move from the current yaw attitude to the expected yaw attitude according to a target yaw moving direction when it is determined that there is a mechanical limit;

and that the target moving direction is a moving direction opposite to the direction in which the gimbal moves from the current attitude to the expected attitude in the shortest path includes that the target yaw moving direction is a moving direction opposite to the direction in which the gimbal moves from the current yaw attitude to the expected yaw attitude in the shortest path.

In some embodiments, in determining whether there is a mechanical limit in the process of the gimbal moving from the current attitude to the expected attitude in the shortest path, the processor 902 is specifically configured to:

determine whether there is a mechanical limit in the process of the gimbal moving from the current pitch attitude to the expected pitch attitude in the shortest path;

in controlling the gimbal to move from the current attitude to the expected attitude according to the target moving direction when it is determined that there is a mechanical limit, the processor 902 is specifically configured to:

control the gimbal to move from the current pitch attitude to the expected pitch attitude according to a target pitch moving direction when it is determined that there is a mechanical limit;

and that the target moving direction is a moving direction opposite to the direction in which the gimbal moves from the current attitude to the expected attitude in the shortest path includes that the target pitch moving direction is a moving direction opposite to the direction in which the gimbal moves from the current pitch attitude to the expected pitch attitude in the shortest path.

In some embodiments, in determining whether there is a mechanical limit in the process of the gimbal moving from the current yaw attitude to the expected yaw attitude in the shortest path, the processor 902 is specifically configured to:

determine a rotation angle at which the gimbal rotates relative to the reference yaw attitude when moving from the current yaw attitude to the expected yaw attitude in the shortest path; and

according to the rotation angle, determine whether there is a mechanical limit in the process of the gimbal moving from the current yaw attitude to the expected yaw attitude in the shortest path.

In some embodiments, in determining, according to the rotation angle, whether there is a mechanical limit in the process of the gimbal moving from the current yaw attitude to the expected yaw attitude, the processor 902 is specifically configured to:

when the rotation angle is greater than a yaw limit angle of the gimbal, determine that there is a mechanical limit in the process of the gimbal moving from the current yaw attitude to the expected yaw attitude in the shortest path.

In some embodiments, the reference yaw attitude is a yaw attitude of the gimbal when the joint angle of the yaw axis motor of the gimbal is 0 degree.

In some embodiments, in determining whether there is a mechanical limit in the process of the gimbal moving from the current pitch attitude to the expected pitch attitude in the shortest path, the processor 902 is specifically configured to:

determine a rotation angle at which the gimbal rotates relative to the reference pitch attitude when the gimbal moves from the current pitch attitude to the expected pitch attitude in the shortest path; and

according to the rotation angle, determine whether there is a mechanical limit in the process of the gimbal moving from the current pitch attitude to the expected pitch attitude in the shortest path.

In some embodiments, in determining, according to the rotation angle, whether there is a mechanical limit in the process of the gimbal moving from the current pitch attitude to the expected pitch attitude, the processor 902 is specifically configured to:

when the rotation angle is greater than the pitch limit angle of the gimbal, determine that there is a mechanical limit in the process of the gimbal moving from the current pitch attitude to the expected pitch attitude in the shortest path.

In some embodiments, the reference pitch attitude is a pitch attitude of the gimbal when the joint angle of the pitch axis motor of the gimbal is 0 degree.

In some embodiments, in determining whether there is a mechanical limit in the process of the gimbal moving from the current yaw attitude to the expected yaw attitude in the shortest path, the processor 902 is specifically configured to:

determine an angle difference between a joint angle of the yaw axis motor of the gimbal in the current yaw attitude and a yaw attitude angle of the gimbal in the expected yaw attitude;

and

determine, according to the angle difference, whether there is a mechanical limit in the process of the gimbal moving from the current yaw attitude to the expected yaw attitude in the shortest path.

In some embodiments, in determining, according to the angle difference, whether there is a mechanical limit in the process of the gimbal moving from the current yaw attitude to the expected yaw attitude in the shortest path, the processor 902 is specifically configured to:

determine whether there is a mechanical limit in the process of the gimbal moving from the current yaw attitude to the expected yaw attitude in the shortest path when the joint angle of the yaw axis motor in the current yaw attitude is within a first yaw joint angle range and when the angle difference satisfies a first preset yaw angle requirement; and

determine whether there is a mechanical limit in the process of the gimbal moving from the current yaw attitude to the expected yaw attitude in the shortest path when the joint angle of the yaw axis motor in the current yaw attitude is within a second yaw joint angle range and when the angle difference satisfies a second preset yaw angle requirement.

In some embodiments, in determining whether there is a mechanical limit in the process of the gimbal moving from the current pitch attitude to the expected pitch attitude in the shortest path, the processor 902 is specifically configured to:

determine an angle difference between a joint angle of the pitch axis motor of the gimbal in the current pitch attitude and a pitch attitude angle of the gimbal in the expected pitch attitude;

and

according to the angle difference, determine whether there is a mechanical limit in the process of the gimbal moving from the current pitch attitude to the expected pitch attitude in the shortest path.

In some embodiments, in determining whether there is a mechanical limit in the process of the gimbal moving from the current pitch attitude to the expected pitch attitude in the shortest path, the processor 902 is specifically configured to:

determine whether there is a mechanical limit in the process of the gimbal moving from the current pitch attitude to the expected pitch attitude in the shortest path when the joint angle of the pitch axis motor in the current pitch attitude is within a first pitch joint angle range and when the angle difference satisfies a first preset pitch angle requirement; and

determine whether there is a mechanical limit in the process of the gimbal moving from the current pitch attitude to the expected pitch attitude in the shortest path when the joint angle of the pitch axis motor in the current pitch attitude is within a second pitch joint angle range and when the angle difference satisfies a second preset pitch angle requirement.

In some embodiments, the processor 902 is further configured to:

control the gimbal to move from the current attitude to the expected attitude in the shortest path when it is determined that there is no mechanical limit.

In some embodiments, the processor 902 is further configured to:

receive a target position sent by an external device, and determine an expected attitude of the gimbal based on the target position.

In some embodiments, the target position is a position in a world coordinate system.

Embodiments of the present disclosure provide an unmanned aerial vehicle, which includes a gimbal as described in the foregoing embodiments.

A person having ordinary skills in the art may appreciate that the various systems, devices, and methods illustrated in the example embodiments may be implemented in other ways. For example, the disclosed embodiments for the device are for illustrative purpose only. Any division of the units are logic divisions. Actual implementation may use other division methods. For example, multiple units or components may be combined, or may be integrated into another system, or some features may be omitted or not executed. Further, couplings, direct couplings, or communication connections may be implemented using interfaces. The indirect couplings or communication connections between devices or units or components may be electrical, mechanical, or any other suitable type.

In the descriptions, when a unit or component is described as a separate unit or component, the separation may or may not be physical separation. The unit or component may or may not be a physical unit or component. The separate units or components may be located at a same place, or may be distributed at various nodes of a grid or network. The actual configuration or distribution of the units or components may be selected or designed based on the actual need of applications.

Various functional units or components may be integrated into a single processing unit, or may exist as separate physical units or components. In some embodiments, two or more units or components may be integrated into a single unit or component. The integrated units may be realized using hardware, or may be realized using hardware and software functioning unit.

The disclosed functions may be realized using software functioning units and may be sold or used as an independent product. The software functioning units may be stored in a computer-readable medium as instructions or codes, such as a non-transitory computer-readable storage medium. Thus, the disclosed methods may be realized using software products. The computer software product may be stored in the computer-readable medium in the form of codes or instructions, which are executable by a computing device (e.g., a personal computer, a server, or a network device, etc.) or a processor to perform all or some of the steps of the disclosed methods. The non-transitory computer-readable storage medium can be any medium that can store program codes, for example, a USB disc, a portable hard disk, a read-only memory (“ROM”), a random-access memory (“RAM”), a magnetic disk, an optical disk, etc.

A person skilled in the art may clearly understand that for the convenience and brevity of the description, only the division of each functional module described above is exemplified. In practical applications, the above function assignment may be completed by different functional modules as needed. That is, the internal structure of the device is divided into different functional modules to perform all or part of the functions described above. For the specific implementation process of the devices described above, refer to the corresponding process in the foregoing method embodiments, details of which are not described herein again.

It should be also noted that the above embodiments are merely illustrative of the technical solutions of the present disclosure, and are not intended to be limiting. Although the present disclosure has been described in detail with reference to the foregoing embodiments, those skilled in the art will understand that the technical solutions described in the foregoing embodiments may be modified, or some or all of the technical features may be equivalently substituted. These modifications or substitutions do not deviate from the scope of the technical solutions of the embodiments of the present disclosure.

What is claimed is:

1. A method for controlling a gimbal, comprising:
determining whether there is a mechanical limit in a process of the gimbal moving from a current attitude to an expected attitude in a shortest path; and
when it is determined that there is a mechanical limit, controlling the gimbal to move from the current attitude to the expected attitude according to a target moving direction, wherein the target moving direction is a moving direction opposite to a direction in which the gimbal moves from the current attitude to the expected attitude in the shortest path.

2. The method according to claim 1, wherein:
determining whether there is a mechanical limit in the process of the gimbal moving from the current attitude to the expected attitude in the shortest path further includes:
determining whether there is a mechanical limit in a process of the gimbal moving from a current yaw attitude to an expected yaw attitude in the shortest path; and
controlling the gimbal to move from the current attitude to the expected attitude according to the target moving direction when it is determined that there is a mechanical limit, wherein the target moving direction is a moving direction opposite to a direction in which the gimbal moves from the current attitude to the expected attitude in the shortest path, further includes:
when it is determined that there is a mechanical limit, controlling the gimbal to move from the current yaw attitude to the expected yaw attitude according to a target yaw moving direction, wherein the target yaw moving direction is a moving direction opposite to a direction in which the gimbal moves from the current yaw attitude to the expected yaw attitude in the shortest path.

3. The method according to claim 1, wherein:
determining whether there is a mechanical limit in the process of the gimbal moving from the current attitude to the expected attitude in the shortest path further includes:
determining whether there is a mechanical limit in a process of the gimbal moving from a current pitch attitude to an expected pitch attitude in the shortest path; and
controlling the gimbal to move from the current attitude to the expected attitude according to the target moving direction when it is determined that there is a mechanical limit, wherein the target moving direction is a moving direction opposite to a direction in which the gimbal moves from the current attitude to the expected attitude in the shortest path, further includes:
when it is determined that there is a mechanical limit, controlling the gimbal to move from the current pitch attitude to the expected pitch attitude according to a target pitch moving direction, wherein the target pitch moving direction is a moving direction opposite to a direction in which the gimbal moves from the current pitch attitude to the expected pitch attitude in the shortest path.

4. The method according to claim 2, wherein determining whether there is a mechanical limit in the process of the gimbal moving from the current yaw attitude to the expected yaw attitude in the shortest path further includes:
determining a rotation angle at which the gimbal rotates relative to a reference yaw attitude when moving from the current yaw attitude to the expected yaw attitude in the shortest path; and
according to the rotation angle, determining whether there is a mechanical limit in the process of the gimbal moving from the current yaw attitude to the expected yaw attitude in the shortest path.

5. The method according to claim 4, wherein determining, according to the rotation angle, whether there is a mechanical limit in the process of the gimbal moving from the current yaw attitude to the expected yaw attitude in the shortest path further includes:
when the rotation angle is greater than a yaw limit angle of the gimbal, determining that there is a mechanical limit in the process of the gimbal moving from the current yaw attitude to the expected yaw attitude in the shortest path.

6. The method according to claim 4, wherein the reference yaw attitude is a yaw attitude of the gimbal when a joint angle of a yaw axis motor of the gimbal is 0 degree.

7. The method according to claim 3, wherein determining whether there is a mechanical limit in the process of the gimbal moving from the current pitch attitude to the expected pitch attitude in the shortest path further includes:
determining a rotation angle at which the gimbal rotates relative to a reference pitch attitude when the gimbal moves from the current pitch attitude to the expected pitch attitude in the shortest path; and
according to the rotation angle, determining whether there is a mechanical limit in the process of the gimbal moving from the current pitch attitude to the expected pitch attitude in the shortest path.

8. The method according to claim 7, wherein determining, according to the rotation angle, whether there is a mechanical limit in the process of the gimbal moving from the current pitch attitude to the expected pitch attitude in the shortest path further includes:
when the rotation angle is greater than a pitch limit angle of the gimbal, determining that there is a mechanical limit in the process of the gimbal moving from the current pitch attitude to the expected pitch attitude in the shortest path.

9. The method according to claim 7, wherein the reference pitch attitude is a pitch attitude of the gimbal when a joint angle of a pitch axis motor of the gimbal is 0 degree.

10. The method according to claim 2, wherein determining whether there is a mechanical limit in the process of the gimbal moving from the current yaw attitude to the expected yaw attitude in the shortest path further includes:
determining an angle difference between a joint angle of a yaw axis motor of the gimbal in the current yaw attitude and a yaw attitude angle of the gimbal in the expected yaw attitude; and
according to the angle difference, determining whether there is a mechanical limit in the process of the gimbal moving from the current yaw attitude to the expected yaw attitude in the shortest path.

11. The method according to claim 10, wherein determining, according to the angle difference, whether there is a mechanical limit in the process of the gimbal moving from the current yaw attitude to the expected yaw attitude in the shortest path further includes:
determining whether there is a mechanical limit in the process of the gimbal moving from the current yaw attitude to the expected yaw attitude in the shortest path when a joint angle of the yaw axis motor in the current yaw attitude is within a first yaw joint angle range and when the angle difference satisfies a first preset yaw angle requirement; and
determining whether there is a mechanical limit in the process of the gimbal moving from the current yaw attitude to the expected yaw attitude in the shortest path when the joint angle of the yaw axis motor in the current yaw attitude is within a second yaw joint angle range and when the angle difference satisfies a second preset yaw angle requirement.

12. The method according to claim 3, wherein determining whether there is a mechanical limit in the process of the gimbal moving from the current pitch attitude to the expected pitch attitude in the shortest path further includes:
determining an angle difference between a joint angle of a pitch axis motor of the gimbal in the current pitch attitude and a pitch attitude angle of the gimbal in the expected pitch attitude; and
according to the angle difference, determining whether there is a mechanical limit in the process of the gimbal moving from the current pitch attitude to the expected pitch attitude in the shortest path.

13. The method according to claim 12, wherein determining, according to the angle difference, whether there is a mechanical limit in the process of the gimbal moving from the current pitch attitude to the expected pitch attitude in the shortest path further includes:
determining whether there is a mechanical limit in the process of the gimbal moving from the current pitch attitude to the expected pitch attitude in the shortest path when a joint angle of the pitch axis motor in the current pitch attitude is within a first pitch joint angle range and when the angle difference satisfies a first preset pitch angle requirement; and
determining whether there is a mechanical limit in the process of the gimbal moving from the current pitch attitude to the expected pitch attitude in the shortest path when the joint angle of the pitch axis motor in the current pitch attitude is within a second pitch joint angle range and when the angle difference satisfies a second preset pitch angle requirement.

14. The method according to claim 1, further comprising:
when it is determined that there is no mechanical limit, controlling the gimbal to move from the current attitude to the expected attitude in the shortest path.

15. The method according to claim 1, further comprising:
receiving a target position sent by an external device; and
determining the expected attitude of the gimbal according to the target position.

16. The method according to claim 15, wherein the target position is a position in a world coordinate system.

17. A gimbal, comprising a memory and a processor, wherein:
the memory is configured to store program code; and
the processor calls the program code and, when the program code is executed, performs the following operations including:
determining whether there is a mechanical limit in a process of a gimbal moving from a current attitude to an expected attitude in a shortest path, and
when it is determined that there is a mechanical limit, controlling the gimbal to move from the current attitude to the expected attitude according to a target moving direction, wherein the target moving direction is a moving direction opposite to a direction in which the gimbal moves from the current attitude to the expected attitude in the shortest path.

18. The gimbal according to claim 17, wherein:
in determining whether there is a mechanical limit in the process of the gimbal moving from the current attitude to the expected attitude in the shortest path, the processor is further configured to:
determine whether there is a mechanical limit in the process of the gimbal moving from a current yaw attitude to an expected yaw attitude in the shortest path;
in controlling the gimbal to move from the current attitude to the expected attitude according to the target moving direction when it is determined that there is a mechanical limit, the processor is further configured to:
control the gimbal to move from the current yaw attitude to the expected yaw attitude according to a target yaw moving direction when it is determined that there is a mechanical limit; and
that the target moving direction is a moving direction opposite to a direction in which the gimbal moves from the current attitude to the expected attitude in the shortest path further includes that the target yaw moving direction is a moving direction opposite to a direction in which the gimbal moves from the current yaw attitude to the expected yaw attitude in the shortest path.

19. The gimbal according to claim 17, wherein:
in determining whether there is a mechanical limit in the process of the gimbal moving from the current attitude to the expected attitude in the shortest path, the processor is further configured to:
determine whether there is a mechanical limit in the process of the gimbal moving from a current pitch attitude to an expected pitch attitude in the shortest path;
in controlling the gimbal to move from the current attitude to the expected attitude according to the target moving direction when it is determined that there is a mechanical limit, the processor is further configured to:
control the gimbal to move from the current pitch attitude to the expected pitch attitude according to a target pitch moving direction when it is determined that there is a mechanical limit; and
that the target moving direction is a moving direction opposite to a direction in which the gimbal moves from the current attitude to the expected attitude in the shortest path further includes that the target pitch moving direction is a moving direction opposite to a direction in which the gimbal moves from the current pitch attitude to the expected pitch attitude in the shortest path.

20. The gimbal according to claim 17, wherein the processor is further configured to:
when it is determined that there is no mechanical limit, control the gimbal to move from the current attitude to the expected attitude in the shortest path.
